(19) United States
(12) Patent Application Publication
(10) Pub. No.: US 2010/0035096 A1
(43) Pub. Date: Feb. 11, 2010

(54) Fuel Cell System Operated by Compressed Air

(76) Inventors: Peter Britz, Neubrandenburg (DE); Udo Martin, Hoehenkirchen (DE); Nicholas Zartenar, Essen (DE)

Correspondence Address: KRIEGSMAN & KRIEGSMAN, 30 TURNPIKE ROAD, SUITE 9, SOUTHBOROUGH, MA, 01772, US

(21) Appl. No.: 11/883,394

(22) PCT Filed: Jan. 27, 2006
(86) PCT No.: PCT/DE2006/000130

§ 371 Date: Jan. 30, 2009

(30) Foreign Application Priority Data
Jan. 31, 2005 (DE) 10 2005 004 426.3

(51) Int. Cl. H01M 8/02; H01M 2/00

(52) U.S. Cl. 429/13; 429/34

(57) ABSTRACT

Described is a fuel cell system wherein at least one fuel cell (8) is supplied with a compressed oxidation gas at least intermittently and/or at least partially, as well as a method for starting up a fuel cell system, said method comprising the following steps: a valve (6) connecting the at least one fuel cell (8) to a compressed gas source (1) supplying a compressed oxidation gas is opened; fuel is supplied to the at least one fuel cell (8); it is checked that the fuel cell system has reached an operating point at which sufficient power is generated for autonomous operation of the fuel cell system and for the consumers to be supplied; and a discrete or gradual switching is carried out from the supply of a compressed oxidation gas stored in the compressed gas storage source (1) to the ambient air supplied by a fan (5). The use of the fuel cell system in an emergency power supply is described.

The present invention relates to a fuel cell system operated by compressed oxidation gas at least intermittently or partially. The invention is further related to a method for starting up a fuel cell system.

Fuel cell systems have already long been known and have gained considerable importance in recent years. Like battery systems, fuel cells generate electric power via a chemical pathway by means of a redox reaction of hydrogen and oxygen, the individual reactants being supplied continuously and the reaction products being discharged continuously.

In a fuel cell, the oxidation and reduction processes proceeding between electrically neutral molecules or atoms are usually spatially separated via an electrolyte. A fuel cell consists basically of an anode part, to which a fuel (for example, hydrogen) is supplied. The fuel cell further has a cathode part, to which an oxidant is supplied. The anode part and cathode part are separated spatially by the electrolyte. Such an electrolyte may involve a membrane, for example. Such membranes are capable of allowing the passage of conducting ions, but of restraining gases. The electrons released during the oxidation are not transferred locally from atom to atom, but rather conducted as electric current through a consumer.

For example, hydrogen as fuel and oxygen as oxidant in the cathode part can be used as gaseous reaction partners for the fuel cell.

If it is desired to operate the fuel cell with a readily available or more easily stored fuel, such as, for instance, natural gas, methanol, propane, gasoline, diesel, or other hydrocarbons in place of hydrogen, the hydrocarbon has to be initially transformed into a hydrogen-rich gas in a device for producing/processing a fuel in a so-called reforming process. This device for producing/processing a fuel consists, for example, of a metering unit having a vaporizer, a reactor for the reforming—for example, for steam reforming, a gas purification [unit], and, often, also at least one catalytic combustor for providing the process heat for the endothermic process—for example, for the reforming process.

A fuel cell system usually consists of a plurality of fuel cells, which, for example, can be formed, in turn, of individual layers. The fuel cells are preferably arranged one after the other—for example, stacked one on top of the other in a sandwichlike manner. A fuel cell system constructed in this way is then referred to as a fuel cell pile or fuel cell stack.

An important field of application for fuel cells is emergency power supply in the case of power failures for important consumers, such as, for example, data processing centers, telecommunication facilities, or hospitals. During a power failure, the fuel cell system for emergency power supply should provide the power required by the consumer being monitored within the shortest period of time. In order to bridge the start-up phase of the fuel cell system during a power interruption, the system is furnished with capacitors or batteries. A conventional system supplied by hydrogen from a compressed gas cylinder and supplied by air oxygen by a fan poses the problem that, during the system start-up of the fuel cell system, a portion of the power stored in the capacitors or batteries is consumed for supplying the air fan for providing the reaction air. Moreover, the fan requires a certain time until it provides an adequate operating pressure and volume flow. Accordingly, the capacitors or batteries have to be designed considerably larger in order to bridge the excess in power and the prolonged start-up time.

In addition, on account of the required short starting time of the fuel cell system for emergency power supply of a few seconds, the actual fuel cell elements are not heated up to the required operating temperature. Nonetheless, even at the low operating temperatures then still existing, a secure supply of air must be assured. A main problem in doing this is the discharge of the product water.

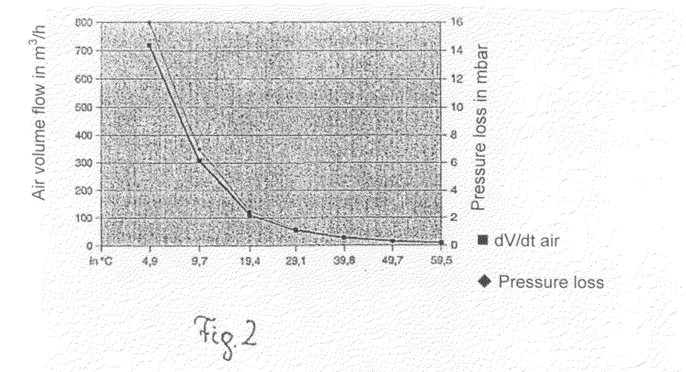

As seen in FIG. 2, there exists a relation between the dew point of the spent air and the air volume flow. Given on the abscissa in FIG. 2 is the dew point in ° C., while the air volume flow in m³/h is plotted on the ordinate. As can be seen in the diagram, an in part many times higher air volume flow is required in order to prevent the air from reaching its dew point in the fuel cell, which would lead to the condensing of the product water. This condensing would, in turn, result, first of all, in the blocking of individual air channels and, subsequently, in the failure of entire cells, because what is involved is a self-enhancing effect.

The diagram of FIG. 2 also shows that, as is to be expected, relatively high pressure losses (as represented on the right ordinate and shown by the curve with diamond points) also occur at relatively high air volume flows. The design and operation of a ventilator for the entire range of the required air volume flow or pressure loss would mean that this ventilator, on the one hand, would have to be of very high capacity in order to afford or compensate for the high volume flows and pressure losses, respectively, and, on the other hand, would have to transport only very little air during normal operation—for example, at a cell temperature of about 50° C.—in order to prevent the cells from drying out too much. Accordingly, the ventilator is operated practically never at its ideal operating point.

The invention is thus based on the problem of providing an improved fuel cell system, which makes it possible to perform a start-up phase of a fuel cell without or with as little externally supplied power as possible and with an optimized air flow. Furthermore, an improved method for starting up a fuel cell system is to be provided.

According to the invention, this problem is solved by providing a fuel cell system having the features according to the independent patent claim 1 as well as a method for starting up a fuel cell system having features according to the independent patent claim 13. Further advantageous configurations, features, aspects, and details ensue from the dependent patent claims, the description, and the attached drawings. Configurations, features, aspects, and details that are described in connection with the fuel cell system of the invention obviously also apply in relation to the method of the invention and vice versa.

The invention is based on the principle of assuring the initial supply of the fuel cell system with oxidation gas not by means of a fan but by a supply of compressed gas.

Accordingly, the invention is related to a fuel cell system in which at least one fuel cell is fed with a compressed oxidation gas at least intermittently and/or at least partially.

A fuel cell system is understood herein to refer to an arrangement of one or more fuel cells—for example, stacks of fuel cells or groups of such stacks together with associated auxiliary assemblies—that is required as a whole to provide a supply of power to a consumer. A compressed oxidation gas is understood herein to refer to a gas present at higher than atmospheric pressure, which is capable of reacting oxidatively with the fuel used for the fuel cell. As a rule, the oxidative substance involves oxygen, so that the compressed oxidation gas can be oxygen gas or a mixture of oxygen gas with other gases.

In a preferred embodiment, the system has at least one compressed gas storage source, which contains pressurized oxidation gas that can be introduced via a line to the cathode side of at least one fuel cell of the system. In another preferred embodiment, an external compressed gas source—for example, a supply of compressed air from outside that is maintained at the required pressure via, for example, a compressor—is used in place of the compressed gas storage source. This may be appropriate, for example, for the supply of emergency power to individual functional areas or buildings for which an elevated risk of an independent power failure exists in comparison to the rest of a campus or similar situation.

It is further preferred that a valve that can control the introduction of the compressed gas to the at least one fuel cell is arranged in the line. Such a valve can then be opened in order to start up a corresponding fuel cell system, for example, that of an emergency power supply.

The valve is preferably an electrically actuated valve. In an especially preferred embodiment, the valve is an electrically actuated valve that is brought into a closed position by applying a current. In the event of a power failure, the valve opens automatically due to the loss of voltage at the valve actuator and affords the supply of compressed gas without the necessity of an additional power supply. In the case of an emergency power supply that is not especially critical in terms of time, that is, for which a power failure is acceptable up to a certain period of time of, for example, several seconds, the fuel supply can be furnished with a corresponding valve, so that the system can dispense entirely with capacitors or batteries.

The valve can preferably be a check valve.

In a specific configuration of the invention, a Venturi nozzle is arranged in the system in such a way that the compressed oxidation gas can entrain ambient air at the Venturi nozzle and can guide it or guides it to the least one fuel cell.

A Venturi nozzle is a device known in the prior art for entraining fluids in a fluid flow by means of an underpressure produced by the fluid flow at constrictions in a tube or in a differently shaped suitable device. A known example of a Venturi device is the water-jet pump, in which a jet of water flowing in a pipe produces suction in a region of air opening into the pipe. The person skilled in the art is familiar with suitable constructions in order to use a fast flow of gas, such as the compressed oxidation gas used in accordance with the invention, to entrain a second flow consisting of ambient air.

This advantageous configuration of the invention makes it possible to transform the very high pressure of the compressed gas into an unequally larger total volume of oxidation gas, so that a relatively small amount of compressed gas is sufficient for starting up the fuel cell system. The Venturi nozzle can be arranged, for example, in the line between the gas storage source and the fuel cells in the flow direction naturally downstream of the valve.

The compressed gas is preferably compressed air. This air is available as ambient air and can therefore be obtained in an especially simple manner from the surroundings. For this purpose, for example, a compressor for filling the compressed gas storage source can be linked to the compressed gas storage source and is then operated when the fuel cell system either adequately delivers power in full operating state in order to drive the compressor as well, that is, when compressed gas is no longer required, or else when the fuel cell system is not in operation, so to speak, as a measure of operational readiness.

The compressed gas can consist of oxygen or of an oxygen-rich gas.

In a further configuration, the compressed gas storage source can be formed from at least one compressed gas cylinder. The number and size of the compressed gas cylinders ensues here from the amount of compressed gas required. Advantageously, the compressed gas cylinders can be filled at a different site and arranged in the fuel cell system in an already filled state. This further reduces the effort needed to design the fuel cell system.

In another preferred embodiment of the invention, another supply for air drawn in by a fan can be connected to the line, it being possible to supply the air alternatively to or simultaneously with the compressed gas to the at least one fuel cell. In this way, it is possible, via only one line, to provide at will either compressed gas or, when adequate electric power is available, fan air, or any desired mixture of the two oxidation gases in order to take into account the gradual start-up of the fuel cell system and the gradual increase in power resulting therefrom.

In an especially preferred embodiment, the fuel cell system is part of an emergency power supply or is itself the emergency power supply, or else a fuel cell system such as described above in accordance with the invention is used as an emergency power system or is a component of an emergency power system.

The present invention further relates to a method to which all of what is said above in reference to the system and vice versa applies, so that reciprocal reference thereto is made.

The method in accordance with the invention serves for starting up a fuel cell system and comprises the following steps:

a) a valve connecting at least one fuel cell to a compressed gas source supplying a compressed oxidation gas is opened;
b) fuel is supplied to the at least one fuel cell;
c) it is checked that the fuel cell system has reached an operating point at which sufficient power is generated for the autonomous operation of the fuel cell system and for the consumers to be supplied; and
d) a discrete or gradual switching is carried out from the supply of a compressed oxidation gas stored in the compressed gas storage source to the ambient air supplied by a fan.

The compressed gas source can be an external compressor-operated source of compressed air and/or, preferably, a compressed gas storage source, for instance, in the form of at least one compressed gas cylinder—for example, in the form of compressed air or oxygen cylinders.

The method provides two key aspects for starting up a fuel cell system—for example, for an emergency power supply—namely, first of all, for switching on a compressed gas source so as to supply the fuel cell system with an oxidation gas without utilizing electric power or, secondly, to accomplish the operating-state-dependent switchover from the compressed gas source, which is unavailable as compressed gas storage after it is empty, to a current-operated fan supply system.

Preferably, the fuel cell system according to the method of the invention is part of an emergency power supply or itself represents an emergency power supply. Also conceivable, however, are other uses in which little power is available for starting up a fuel cell system—for example, for battery-damaging uses in offshore or cold-temperature environments or for improving reliable start-up in automobiles even after prolonged standing in a cold environment.

Preferably, the method according to the invention has the following preliminary step: it is checked whether it is necessary to start up a fuel cell system on the basis of a power supply state of a monitored system of consumers.

In an especially simple variant, this is effected, as already described above, by way of an electrically controlled valve, which simply opens when a power failure occurs. Normally used, of course, is an electronic circuit, which also initially provides the required capacitor or battery current, as is familiar to professionals in the field of emergency power supply.

In order to ensure the ability to use this method repeatedly to start up a fuel cell system, it is additionally preferred that, after the operating point is reached or after the end of a fuel cell operation, a compressor refills the compressed gas storage source once again, preferably by means of an automatic control and without action by an operator.

The method can finally be characterized in that it is carried out during the starting phase of a fuel cell system simultaneously with the supply of air to the at least one fuel cell by a fan, in order to supply the at least one fuel cell that is still at operating temperature with sufficient oxidation gas. In this aspect of the present method, the provided compressed oxidation gas does not alone assume the role of the oxidation gas in the fuel cell, but rather serves only supplementally for the supply of air via a fan. In this way, it is possible to prevent the reaching of the dew point described in the introduction with the associated negative consequences for the efficiency of the fuel cells, in that, at the beginning of operation of the fuel cell system by compressed gas, considerably more oxidation gas is supplied to the fuel cell and thus the dew point is not reached.

The present invention will now be described in greater detail on the basis of an abstract exemplary embodiment with reference to the attached drawings, in which the following is illustrated:

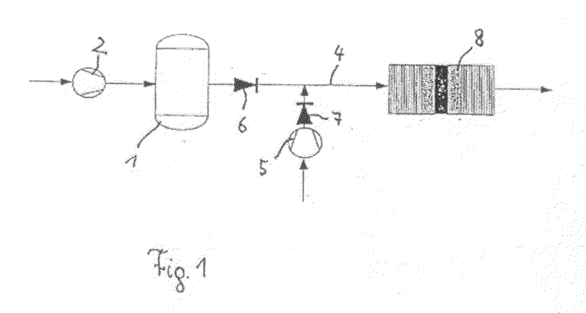

FIG. 1 shows, in schematic illustration, an embodiment of the fuel cell system according to the present invention; and

FIG. 2 shows, as a diagram, the relation between the dew point and the air throughput as well as the pressure loss.

The solution according to the invention of the outlined problem lies in the storage of compressed air. Because the fuel cell system is not permanently required, particularly for emergency power supplies, but rather only in the event of a failure of normal power supply, it is possible during the phase with mains power supply to load a compressed air tank 1 by means of a compressor 2 via line 3. This stored compressed air can be utilized in the first few minutes of a power failure to start up the fuel cell system as fast as possible and in a power-conserving manner. The air fan 5 need be used only after a certain period of time—for example, after a few minutes—when the air from the compressed air tank 1 has been consumed. At this point in time, however, the fuel cell system already provides sufficient power in order to supply the external and also internal consumers. Should the power failure last for less than a few minutes, it would even be conceivable in this case that the fan 5 does not need to start up. The power consumption of the compressor 2 does play any substantial role, because it is supplied directly from a power network of the consumer and does not appear in the power balance of the fuel cell system. For controlling the supply of compressed gas or ambient air, respectively, via the line 4, a check valve 6 is arranged between the fuel cells and the compressed gas tank 1 and another valve 7 is arranged between the fan 5 and the fuel cells 8.

In an exemplary calculation, a fuel cell system for 1 kW of electrical power requires approximately 1 m³/h of hydrogen and 5 m³/h of ambient air; that is, per minute of start-up time, the system requires approximately 100 L of air per kW. Accordingly, a 2-kW system requires, for 2 minutes of start-up time, approximately 400 L of air, that is, a storage source of 40-L capacity and a 10-bar operating pressure of the compressor.

As already described, the diagram in FIG. 2 shows the dependence of the air volume flow and pressure loss on the dew point at the fuel cell output. This graph shows that a division of the air supply into two systems is extremely appropriate, the first system, namely, the charging with compressed air, being of very high capacity, that is, compensating for a high volume flow and a high pressure loss, and being required during start-up, and the second system, namely, a normal fan, being employed for normal operation and therefore having to fulfill other requirements.

Another advantage could even consist in the fact that, in the case of a cold start-up, the transport of product water might be possible not in the gas phase, that is, above the dew point, as water vapor, but even as liquid phase, because, through the supply of compressed gas, sufficient pressure for a transport of droplets in the so-called flow field of the fuel cell might be available.

The present invention makes possible a start-up operation of a fuel cell system with minimal power input at optimal efficiency.

1. A fuel cell system in which at least one fuel cell is supplied with a compressed oxidation gas at least intermittently and/or at least partially.

2. The fuel cell system according to claim 1, further characterized in that it has at least one compressed gas storage source, which contains pressurized oxidation gas that can be supplied via a line to the cathode side of at least one fuel cell of the system.

3. The fuel cell system according to claim 2, further characterized in that a valve that can control the introduction of compressed gas to the at least one fuel cell is arranged in the line.

4. The fuel cell system according to claim 3, further characterized in that the valve is an electrically actuated valve.

5. The fuel cell system according to claim 3, further characterized in that the valve is a check valve.

6. The fuel cell system according to claim 1, further characterized in that a Venturi nozzle is arranged in the system in such a way that the compressed oxidation gas can entrain ambient air at the Venturi nozzle and can guide it or guides it to the at least one fuel cell.

7. The fuel cell system according to claim 1, further characterized in that the compressed gas is compressed air.

8. The fuel cell system according to claim 7, further characterized in that the compressed air is air taken from the surroundings.

9. The fuel cell system according to claim 1, further characterized in that a compressor for filling the compressed gas storage source is linked to the compressed gas storage source.

10. The fuel cell system according to claim 1, further characterized in that the compressed gas storage source is formed from at least one compressed gas cylinder.

11. The fuel cell system according to claim 2, further characterized in that another supply for air drawn in by a fan can be connected to the line, it being possible to supply the air alternatively or simultaneously with the compressed gas to the at least one fuel cell.

12. The fuel cell system according to claim 1, further characterized in that the fuel cell system is part of an emergency power supply or constitutes an emergency power supply.

13. A method for starting up a fuel cell system, characterized by the following steps: a valve connecting the at least one fuel cell to a compressed gas source supplying a compressed oxidation gas is opened; fuel is supplied to the at least one fuel cell; it is checked that the fuel cell system has reached an operating point at which sufficient power is generated for the autonomous operation of the fuel cell system and for the consumers to be supplied; and a discrete or gradual switching is carried out from the supply of a compressed oxidation gas stored in the compressed gas storage source to the ambient air supplied by a fan.

14. The method according to claim 13, further characterized in that the fuel cell system is part of an emergency power supply or constitutes an emergency power supply.

15. The method according to claim 13, further characterized in that it has the following preliminary step: it is checked whether it is necessary to start up the fuel cell system on the basis of a power supply state of a monitored system of consumers.

16. The method according to claim 13, further characterized in that the valve opens automatically when there is a failure of the supplied power.

17. The method according to claim 13, further characterized in that, after the operating point is reached or after the end of a fuel cell operation, a compressor fills the compressed air storage source once again.

18. The method according to claim 13, further characterized in that, during the starting phase of a fuel cell system, a supply of air to the at least one fuel cell by a fan is carried out simultaneously in order to supply the at least one fuel cell that is not yet at operating temperature with sufficient oxidation gas.

19. The use of a fuel cell system according to claim 1 as an emergency power supply system or as component of an emergency power supply system.
